(19) United States
(12) Patent Application Publication
(10) Pub. No.: US 2018/0240046 A1
(43) Pub. Date: Aug. 23, 2018

(54) DISPLAY SYSTEM FOR DISPLAYING ANALYTICAL INFORMATION, METHOD, AND PROGRAM

(71) Applicant: NEC Corporation, Tokyo (JP)

(72) Inventor: Keisuke UMEZU, Tokyo (JP)

(73) Assignee: NEC Corporation, Tokyo (JP)

(21) Appl. No.: 15/548,522

(22) PCT Filed: Jan. 26, 2016
(86) PCT No.: PCT/JP2016/000368

§ 371 Date: Aug. 3, 2017

(30) Foreign Application Priority Data
Feb. 9, 2015 (JP) 2015-023082

(51) Int. Cl. G06Q 10/04; G06F 17/18

(52) U.S. Cl. CPC G06Q 10/04; G06F 17/18

(57) ABSTRACT

Provided is a display system for displaying analytical information that allows a person to easily analyze which term in the estimation equation causes the estimation failure, when the measured value largely deviates from the estimated value. A calculation means (3) uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value. A display means (4) displays a stacked bar graph in which each product calculated by the calculation means (3) and a constant term in the estimation equation are stacked, for each estimated value, and respectively displays a change in the estimated value and a change in a measured value corresponding to the estimated value.

### TECHNICAL FIELD

The present invention relates to a display system for displaying analytical information, a method for displaying analytical information, and a program for displaying analytical information to be utilized for analysis of an estimation equation to be used for calculating an estimated value.

### BACKGROUND ART

A technique related to graph display is described in PTL 1 and 2, for example. In PTL 1, a device is described for displaying water leakage of each area with a stacked area graph. In addition, PTL 2 discloses displaying power with a stacked bar graph. In FIG. 9 of PTL 2, an example of the stacked bar graph is illustrated.

### CITATION LIST

### Patent Literature

PTL 1: Japanese Patent Application Laid-Open No. 2014-145603

PTL 2: Japanese Patent Application Laid-Open No. 2014-005465

### SUMMARY OF INVENTION

### Technical Problem

In estimation of sales or the like, an estimated value may be calculated by using an estimation equation. Incidentally, here, estimation of sales is exemplified; however, an estimation target is not particularly limited. Hereinafter, a general technique for estimated value calculation will be described.

An estimation equation to be used for estimating something is expressed in the following form.

y=a₁x₁+a₂x₂+ . . . +aₙxₙ+b Equation (1)

In Equation (1), y is an estimated value. In addition, x₁, x₂, . . . , xₙ are explanatory variables. Each of a₁, a₂, . . . , aₙ is a coefficient of the corresponding explanatory variable. A constant term is represented by b. The number of explanatory variables is n, and n is not particularly limited. The estimation equation indicated in Equation (1) is generated by using learning data in advance. When a value of each explanatory variable is given, the estimated value y can be calculated by using Equation (1). In some cases, a plurality of estimation equations is generated, and an estimation equation to be used for estimated value calculation is selected by using a selection model obtained by learning.

There are a continuous variable and a categorical variable as explanatory variable types.

The continuous variable takes a numerical value as a value. An example of the continuous variable is, for example, air temperature.

The categorical variable takes an item as a value. An example of the categorical variable is, for example, “forecast weather.” When the categorical variable is “forecast weather,” a possible value of this categorical variable is, for example, “sunny,” “cloudy,” “rainy,” “cloudy with occasional rain,” or “sunny with occasional rain.”

One continuous variable corresponds to one of the explanatory variables x₁, x₂, xₙ in the estimation equation. When a value (numerical value) of the continuous variable is given, the value is substituted into the corresponding explanatory variable in the estimation equation.

In addition, each value of one categorical variable corresponds to one of the explanatory variables x₁, x₂, xₙ in the estimation equation. For example, each possible value of “forecast weather” being the categorical variable (each item such as “sunny,” or “cloudy”) corresponds to one of the explanatory variables x₁, x₂, . . . , xₙ in the estimation equation. Therefore, one categorical variable corresponds to a plurality of explanatory variables in the estimation equation. When a value (item) of the categorical variable is given, any one of two values (for example, 0 and 1) is substituted into each explanatory variable in the estimation equation corresponding to each value of the categorical variable. More specifically, when the value (item) of the categorical variable is given, 1 is substituted into an explanatory variable in the estimation equation corresponding to the value, and 0 is substituted into each explanatory variable in the estimation equation corresponding to each of other values of the categorical variable. For example, when the value of “forecast weather” being the categorical variable is “sunny,” 1 is substituted into the explanatory variable corresponding to “sunny,” and 0 is substituted into each explanatory variable corresponding to each of other items such as “cloudy,” and “rainy.”

In this way, the value of the continuous variable is input into the explanatory variable in the estimation equation corresponding to the continuous variable, and any one of the two values is input into each explanatory variable in the estimation equation corresponding to each value of the categorical variable, whereby the estimated value y is obtained.

An analyst analyzes accuracy of the estimation equation obtained by learning. In such an analysis process, when a measured value of the estimation target largely deviates from the estimated value, it is preferable to be able to easily specify which term in the estimation equation causes an estimation failure.

In addition, for an operator of a device for calculating the estimated value (estimation device), when the measured value largely deviates from the estimated value, it is preferable to be able to easily specify which term in the estimation equation causes the estimation failure.

Therefore, it is an object of the present invention to provide a display system for displaying analytical information, a method for displaying analytical information, and a program for displaying analytical information capable of solving a technical issue for allowing a person to easily analyze which term in the estimation equation causes the estimation failure, when the measured value largely deviates from the estimated value.

### Solution to Problem

A display system for displaying analytical information according to the present invention includes: a calculation means that uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and a display means that displays a stacked bar graph in which each product calculated by the calculation means and a constant term in the estimation equation are stacked, for each estimated value, and respectively displays a change in the estimated value and a change in a measured value corresponding to the estimated value.

In addition, a method for displaying analytical information according to the present invention includes: using values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and displaying a stacked bar graph in which each product calculated and a constant term in the estimation equation are stacked, for each estimated value, and respectively displaying a change in the estimated value and a change in a measured value corresponding to the estimated value.

In addition, a program for displaying analytical information according to the present invention causes a computer to execute: a calculation process that uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and a display process that displays a stacked bar graph in which each product calculated in the calculation process and a constant term in the estimation equation are stacked, for each estimated value, and respectively displays a change in the estimated value and a change in a measured value corresponding to the estimated value.

### Advantageous Effects of Invention

With the technical means of the present invention, a technical effect can be obtained that allows a person to easily analyze which term in the estimation equation causes the estimation failure, when the measured value largely deviates from the estimated value.

### BRIEF DESCRIPTION OF DRAWINGS

FIG. 1 It depicts a schematic diagram illustrating a learning device and an estimation device.

FIG. 2 It depicts a schematic diagram illustrating an example of a selection model.

FIG. 3 It depicts a diagram illustrating an example of estimation data.

FIG. 4 It depicts a diagram illustrating an example of information output by the estimation device.

FIG. 5 It depicts a block diagram illustrating an example of a display system for displaying analytical information of a first exemplary embodiment of the present invention.

FIG. 6 It depicts an explanatory diagram illustrating an example of a graph displayed by a display means 4.

FIG. 7 It depicts a flowchart illustrating an example of processing progress of the first exemplary embodiment.

FIG. 8 It depicts a block diagram illustrating an example of a display system for displaying analytical information of a second exemplary embodiment of the present invention.

FIG. 9 It depicts a flowchart illustrating an example of processing progress of the second exemplary embodiment.

FIG. 10 It depicts an explanatory diagram illustrating an example of a graph displayed in step S5.

FIG. 11 It depicts a block diagram illustrating an example of a display system for displaying analytical information of a third exemplary embodiment of the present invention.

FIG. 12 It depicts a flowchart illustrating an example of processing progress of the third exemplary embodiment.

FIG. 13 It depicts a schematic block diagram illustrating a configuration example of a computer according to each exemplary embodiment of the present invention.

FIG. 14 It depicts a block diagram illustrating an outline of a display system for displaying analytical information of the present invention.

### DESCRIPTION OF EMBODIMENTS

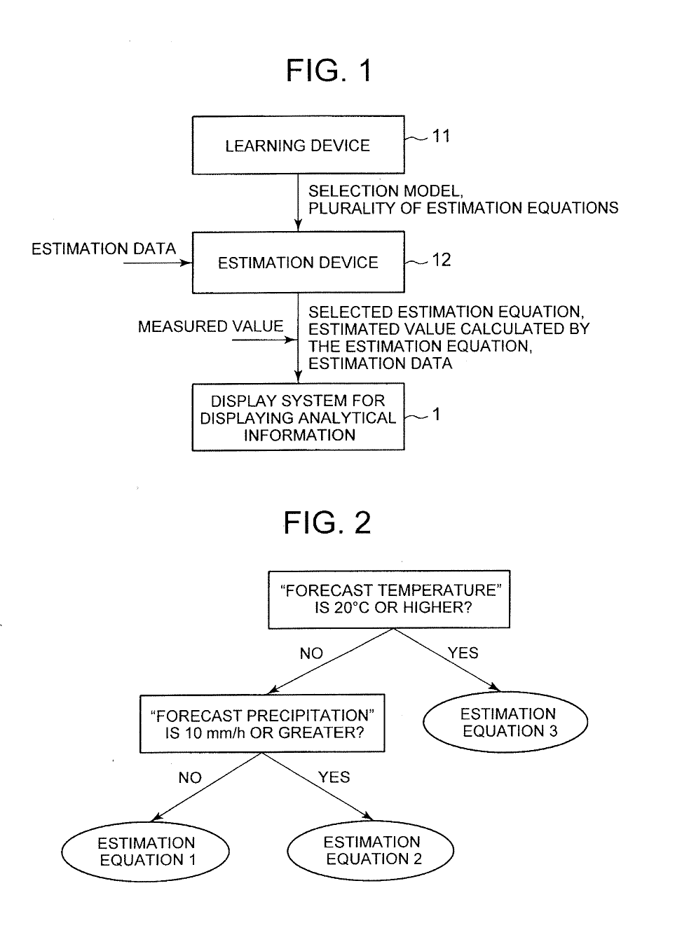

First, as a description related to the display system for displaying analytical information of the present invention, a learning device and an estimation device will be described. FIG. 1 is a schematic diagram illustrating the learning device and the estimation device. To facilitate understanding, a description will be made using a specific example in which the number of sales of rice balls in a convenience store is estimated based on a value of an explanatory variable such as “forecast air temperature,” “forecast precipitation,” or “forecast weather.”

A learning device 11 uses learning data in advance to generate a plurality of estimation equations. In this example, the number of sales of rice balls is an estimation target in each estimation equation. Each estimation equation is generated in a form expressed in Equation (1). However, a value of a coefficient or a constant term is defined for each estimation equation. The plurality of estimation equations generated by the learning device 11 is used in an estimation device 12.

Estimation data are input to the estimation device 12, and the estimation device 12 selects an estimation equation according to a condition satisfied by the estimation data among the plurality of estimation equations. Then, the estimation device 12 substitutes a value specified from the estimation data into the explanatory variable of the selected estimation equation, to calculate an estimated value.

A plurality of sets is input to the display system for displaying analytical information of the present invention, each associating the estimated value calculated by the estimation device 12, the estimation equation and the estimation data used in calculation of the estimated value, and a measured value corresponding to the estimated value (for example, the number of rice balls actually sold) with each other. The estimated value in each set described above is calculated by the estimation device 12 in advance. The measured value is associated with the estimated value, the estimation data, and the estimation equation by, for example, an operator of a display system for displaying analytical information 1 (for example, an analyst analyzing accuracy of the estimation equation, or an operator of the estimation device 12). Incidentally, depending on the exemplary embodiment, information as described above is not always input.

The estimation device 12 selects an estimation equation according to the estimation data. For that reason, the learning device 11 generates a model for selecting the estimation equation according to the estimation data (hereinafter, referred to as a selection model). FIG. 2 is a schematic diagram illustrating an example of the selection model. In an example illustrated in FIG. 2, a case is exemplified where the selection model is a tree structure model in which the estimation equation is a leaf node, and a condition related to the estimation data is defined in a node other than the leaf node. In addition, in the selection model illustrated in FIG. 2, there are two child nodes in each node other than the leaf node. Here, a description will be made using an example in which the selection model is the tree structure model as exemplified in FIG. 2; however, a form of the selection model is not limited to the tree structure model.

The selection model is also given to the estimation device 12 together with the plurality of estimation equations. It is also assumed that the estimation data including values of forecast air temperature and forecast precipitation are input to the estimation device 12. Hereupon, the estimation device 12, starting from a root node of the selection model, traces nodes while repeating selection of any one of two child nodes depending on whether or not the estimation data satisfies the condition indicated by the nodes. Then, the estimation device 12, when reaching the leaf node, selects the estimation equation indicated by the leaf node. Then, the estimation device 12 uses the estimation equation and the estimation data, to calculate the estimated value.

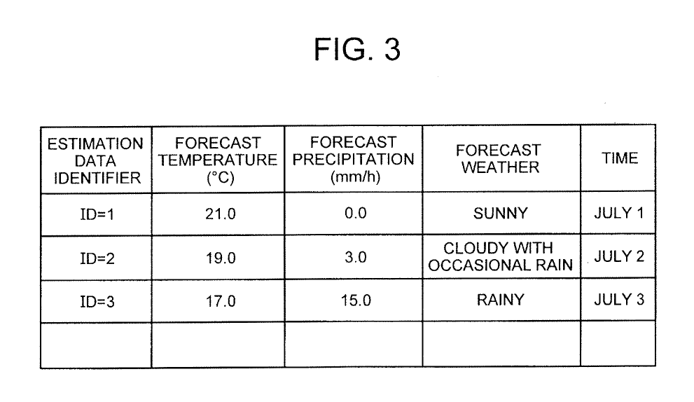

To facilitate understanding, the estimation device 12 will be described with reference to a specific example. FIG. 3 is a diagram illustrating an example of estimation data input to the estimation device 12. In FIG. 3, a set of estimation data is exemplified. Information corresponding to a “row” in FIG. 3 corresponds to one piece of the estimation data. Each piece of the estimation data includes values of two or more types of attributes. “Forecast air temperature,” “forecast precipitation,” and “forecast weather” illustrated in FIG. 3 correspond to the attributes. The attributes included in the estimation data are items of data to be collected for estimated value calculation. In an example illustrated in FIG. 3, the estimation data also include an ID for identifying the estimation data and information indicating time. Incidentally, in FIG. 3, “one day” is taken as a unit of time. In FIG. 3, the set of the estimation data is represented by a table format; however, a form of the estimation data is not limited to the form illustrated in FIG. 3.

An example of operation of the estimation device 12 will be described based on the estimation data exemplified in FIG. 3 and the selection model illustrated in FIG. 2. The estimation device 12 accepts an input of estimation data identified by an ID=1 (see FIG. 3). In the estimation data identified by the ID=1, a value of “forecast air temperature” is 21.0° C. For this reason, the estimation device 12 selects an estimation equation 3 with the selection model illustrated in FIG. 2. Similarly, the estimation device 12 accepts an input of estimation data identified by an ID=2 (see FIG. 3). In the estimation data identified by the ID=2, a value of “forecast air temperature” is 19.0° C., and a value of “forecast precipitation” is 3.0 mm/h. For this reason, the estimation device 12 selects an estimation equation 1 with the selection model illustrated in FIG. 2. Similarly, the estimation device 12 accepts an input of estimation data identified by an ID=3 (see FIG. 3). In the estimation data identified by the ID=3, a value of “forecast air temperature” is 17.0° C., and a value of “forecast precipitation” is 15 mm/h. For this reason, the estimation device 12 selects an estimation equation 2 with the selection model illustrated in FIG. 2.

The estimation device 12 substitutes a value of the explanatory variable specified from each of the values of the attributes included in the estimation data into the explanatory variable in the estimation equation, to calculate the estimated value. When the attribute is a continuous variable, the estimation device 12 only needs to substitute a value of the attribute into the corresponding explanatory variable in the estimation equation. In addition, when the attribute is a categorical variable, the estimation device 12 only needs to substitute any value (for example, 1) of two values (for example, 0 or 1) into the explanatory variable in the estimation equation corresponding to a value of the attribute, and substitute another value (for example, 0) into the explanatory variable in the estimation equation corresponding to another possible value of the attribute. For example, when the value of “forecast weather” is “sunny,” the estimation device 12 only needs to substitute 1 into the explanatory variable in the estimation equation corresponding to “sunny,” and substitute 0 into explanatory variables respectively corresponding to other values such as “cloudy,” “rainy,” “cloudy with occasional rain,” and “sunny with occasional rain.”

In this way, the estimation device 12 substitutes the value into each of the explanatory variables x₁, x₂, . . . , xₙ of the estimation equation expressed in the form of Equation (1), to calculate the estimated value.

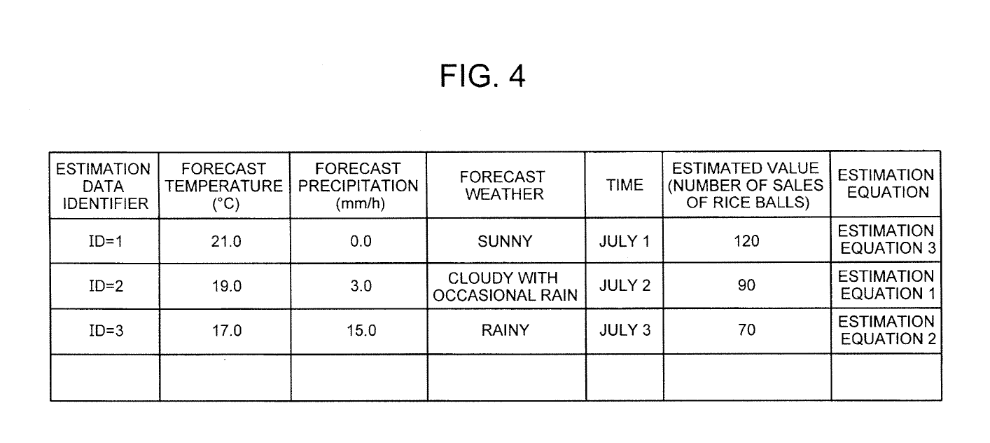

FIG. 4 is a diagram illustrating an example of information output by the estimation device 12. As illustrated in FIG. 4, the estimation device 12 outputs the information to which the estimation equation selected by using the estimation data, and the estimated value calculated by using the estimation data and the estimation equation are added, to each estimation data. In FIG. 4, a case is illustrated where the estimation device 12 uses the estimation data identified by the ID=1 and the estimation equation 3 to calculate an estimated value “120.” In addition, a case is illustrated where the estimation device 12 uses the estimation data identified by the ID=2 and the estimation equation 1 to calculate an estimated value “90.” Further, a case is illustrated where the estimation device 12 uses the estimation data identified by the ID=3 and the estimation equation 2 to calculate an estimated value “70.”

In addition, the operator of the display system for displaying analytical information 1 adds a measured value corresponding to each estimated value to the information illustrated in FIG. 4. In other words, the operator adds the measured value for each row illustrated in FIG. 4. For example, the number of rice balls actually sold in July 1, the number of rice balls actually sold in July 2, and the like are added to the information illustrated in FIG. 4. Then, the information is input to the display system for displaying analytical information 1.

Incidentally, an example of the learning device 11 as illustrated in FIG. 1 is disclosed in the following reference literature, for example.

Reference Literature: US 2014/0222741 A1

Incidentally, in the above description, a case has been described where the learning device 11 generates the plurality of estimation equations and the selection model, and the estimation device 12 selects one estimation equation for each piece of the estimation data. The learning device 11 may generate one estimation equation. For example, the learning device 11 may generate one estimation equation with multiple regression analysis or the like. In this case, the learning device 11 does not have to generate the selection model. In addition, in this case, the estimation device 12 uses the one estimation equation to calculate the estimated value, based on each piece of the estimation data.

In each of the following exemplary embodiments, a description will be made by using an example in which the learning device 11 generates the plurality of estimation equations and the selection model, and the estimation device 12 selects one estimation equation for each piece of the estimation data.

### First Exemplary Embodiment

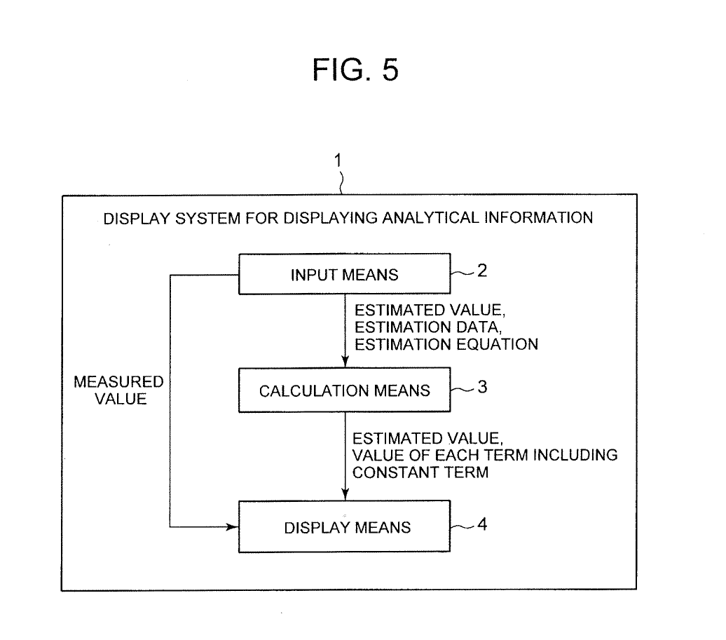

FIG. 5 is a block diagram illustrating an example of a display system for displaying analytical information of a first exemplary embodiment of the present invention. The display system for displaying analytical information 1 includes an input means 2, a calculation means 3, and a display means 4.

The input means 2 is an input device to which a plurality of sets is input, the sets each associating an estimated value calculated by the estimation device 12, estimation data used in calculation of the estimated value, an estimation equation used in calculation of the estimated value, and a measured value with each other. For example, information in which the measured value is further added to each row exemplified in FIG. 4 is input to the input means 2. Incidentally, as described above, each piece of the estimation data includes values of two or more types of attributes.

The calculation means 3 takes in the estimated value, the estimation data, and the estimation equation for each set from the information input to the input means 2. In addition, the display means 4 takes in the measured value for each set from the information input to the input means 2.

The calculation means 3 refers to a value of each attribute in the estimation data used in calculation of the estimated value, and a coefficient of an explanatory variable in the estimation equation used in calculation of the estimated value, for each estimated value (in other words, for each set described above). Then, the calculation means 3 calculates a product of a value of the explanatory variable specified from each of the values of the attributes and the coefficient corresponding to the explanatory variable.

Here, when the attribute is a continuous variable, the attribute corresponds to one explanatory variable in the estimation equation. The value of the explanatory variable specified from the value of the attribute is the value itself of the attribute. Therefore, when the attribute is a continuous variable, the calculation means 3 calculates a product of the value of the attribute and the coefficient of the explanatory variable corresponding to the attribute. For example, it is assumed that “forecast air temperature” is 21.0° C. In addition, it is assumed that the explanatory variable corresponding to the attribute is x₁ (see Equation (1)). In this case, the calculation means 3 calculates a product a₁x₁ of the value of the attribute “21.0” and a coefficient a₁ of the explanatory variable x₁ in the estimation equation.

In addition, when the attribute is a categorical variable, each possible value of the attribute corresponds to one explanatory variable in the estimation equation. For example, the attribute “forecast weather” can take values such as “sunny,” “cloudy,” and “rainy.” Then, each of the values of “sunny,” “cloudy,” and “rainy” corresponds to one explanatory variable in the estimation equation. In this case, the calculation means 3 specifies each of the values of those explanatory variables to any of two values (in this example, it is assumed that the value is 0 or 1) depending on the value of the attribute. For example, it is assumed that the value of “forecast weather” in the estimation data is “sunny.” Also, it is assumed that the explanatory variable corresponding to “sunny” is x₂, and the explanatory variables corresponding to the values such as “cloudy,” and “rainy” are x₃, x₄, . . . , xₘ. However, m<n. n is the number of the explanatory variables (see Equation (1)). At this time, the calculation means 3 sets the value of the explanatory variable x₂ corresponding to “sunny” to “1,” and sets each of the values of the explanatory variables x₃, x₄, . . . , xₘ corresponding to the values such as “cloudy,” and “rainy” to “0.” Then, the calculation means 3 calculates the product of the value of the explanatory variable and the corresponding coefficient, for each explanatory variable. That is, the calculation means 3 calculates a₂x₂, a₃x₃, aₘxₘ.

By calculation as described above, the calculation means 3 calculates each value of terms from a₁x₁ to aₙxₙ in the estimation equation. The calculation means 3 executes the calculation for each estimated value (in other words, for each set described above). In addition, the calculation means 3 uses the coefficient in the estimation equation used in calculation of the estimated value to execute the calculation described above. Since coefficients a₁ to aₙ and a constant term b are defined for each estimation equation, each of the coefficients a₁ to aₙ used for calculation of the product is not always constant. In addition, the constant term b is not always constant.

Incidentally, when the coefficient is 0, or when the value of the explanatory variable specified from the value of the attribute is 0, the product is 0.

The calculation means 3 inputs each set of the values of the terms in the estimation equation calculated for each estimated value and the value of the constant term b, the estimated value, and the time corresponding to the estimated value, to the display means 4.

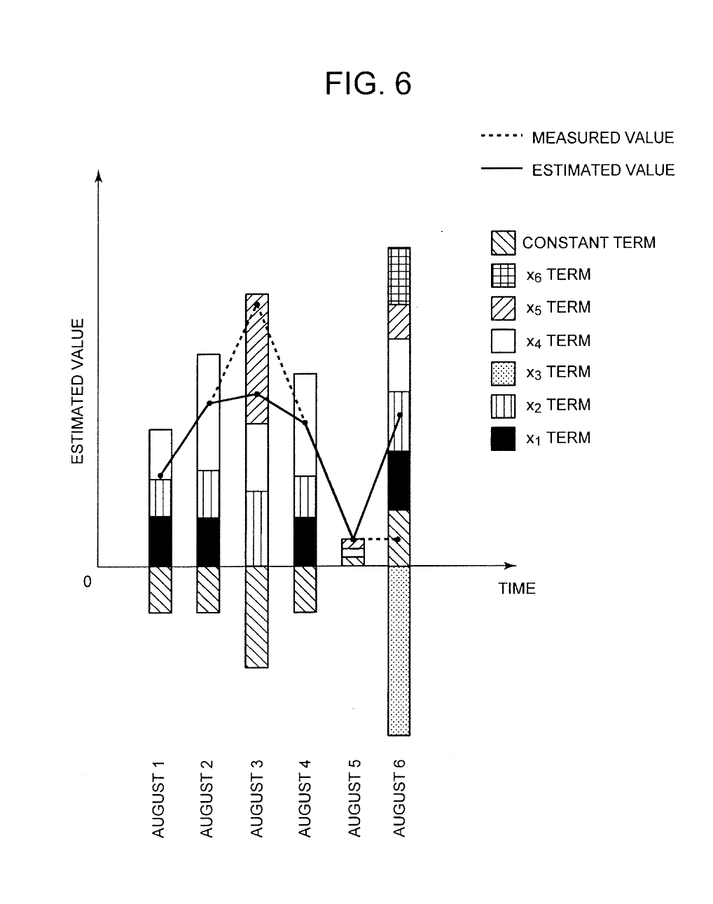

The display means 4 displays a graph in which the horizontal axis is the time and the vertical axis is the estimated value. FIG. 6 is an explanatory diagram illustrating an example of a graph displayed by the display means 4.

The display means 4 displays a stacked bar graph in which each product (that is, each term from a₁x₁ to aₙxₙ) calculated by the calculation means 3 and the constant term b (see Equation (1)) are stacked, for each estimated value, in chronological order. FIG. 6 illustrates the stacked bar graph. In addition, in FIG. 6, the stacked bar graph is illustrated in a case where the terms from x₁ to x₆ and the constant term are stacked. As described above, there is a case where the calculated product is 0. In addition, there is also a case where the constant term is 0. The term whose value is 0 as described above does not appear on the stacked bar graph. For example, in the example illustrated in FIG. 6, on the graph corresponding to “August 1,” none of the terms x₃, x₅, x₆ is not displayed. This means that each of the terms x₃, x₅, x₆ is 0.

The display means 4, in display of the stacked bar graph, when the product calculated by the calculation means 3 is positive, stacks and displays the product in a positive direction, and when the product calculated by the calculation means 3 is negative, stacks and displays the product in a negative direction. Similarly, the display means 4, when the constant term in the estimation equation is positive, stacks and displays the constant term in the positive direction, and when the constant term is negative, stacks and displays the constant term in the negative direction. In the example illustrated in FIG. 6, the position of the vertical axis crossing the horizontal axis means the estimated value “0.” Therefore, in the example illustrated in FIG. 6, to stack the product and the constant term in the positive direction means to stack them in the upper side from the horizontal axis. In addition, to stack the product and the constant term in the negative direction means to stack them in the lower side from the horizontal axis.

Incidentally, in the example illustrated in FIG. 6, the value of the constant term (height of stack) is different between the bar graphs for “August 2,” “August 3,” “August 5,” and “August 6.” This is because the estimation equations used for estimated value calculation for respective dates are different from each other.

As described above, the display means 4 displays the stacked bar graph, and uses the estimated value input from the calculation means 3 to display a change in the estimated value with the time change. Further, the display means 4 uses the measured value taken for each set from the information input to the input means 2 to display the change in the measured value with the time change. At each time (in this example, each date), the estimated value and the measured value are associated with each other.

In FIG. 6, a case is exemplified where the display means 4 respectively displays the change in the estimated value and the change in the measured value with the time change with line graphs. In addition, in the example illustrated in FIG. 6, the display means 4 displays the change in the estimated value with the solid line graph, and displays the change in the measured value with the dashed line graph. In addition, in FIG. 6, for the portion where the solid line graph and the dashed line graph overlap each other, only the solid line is indicated.

The display means 4 uses common vertical and horizontal axes to superimpose and display the bar graph and two types of line graphs.

As described above, the display means 4, when the product and the constant term are positive, stacks the product and the constant term in the positive direction, and when the product and the constant term are negative, stacks the product and the constant term in the negative direction. As can be seen from Equation (1), the estimated value y is a sum of each product and the constant term. Therefore, a value obtained by subtracting a height stacked in the negative direction (an absolute value of a sum of the negative product and constant term) from a height stacked in the positive direction (an absolute value of a sum of the positive product and constant term) is equal to the estimated value. For example, in the bar graph for “August 1” illustrated in FIG. 6, it is assumed that an absolute value of a sum of the x₁ term, the x₂ term, and the x₄ term stacked in the positive direction is P. In addition, in the bar graph, it is assumed that an absolute value of the constant term stacked in the negative direction is Q. In this case, the estimated value for “August 1” matches P-Q.

When there is no negative product or constant term, the sum of the product and constant term stacked in the positive direction matches the estimated value (for example, see the bar graph for “August 5” illustrated in FIG. 6).

The calculation means 3 and the display means 4 are realized by a CPU of a computer including a display device, for example. In this case, the CPU only needs to read a program for displaying analytical information from a program recording medium such as a program storage device (not illustrated in FIG. 5) of the computer, and operate as the calculation means 3 and the display means 4 in accordance with the program for displaying analytical information. In the display means 4, a part for defining the graph and displaying the graph on the display device is realized by the CPU. In the display means 4, a part for actually performing display is realized by the display device. Regarding this point, the same applies to each exemplary embodiment described later. In addition, the calculation means 3 and the display means 4 may be realized by separate hardware devices, respectively.

In addition, the display system for displaying analytical information 1 may have a configuration in which two or more physically separated devices are connected to each other by wire or wirelessly. Also regarding this point, the same applies to each exemplary embodiment described later.

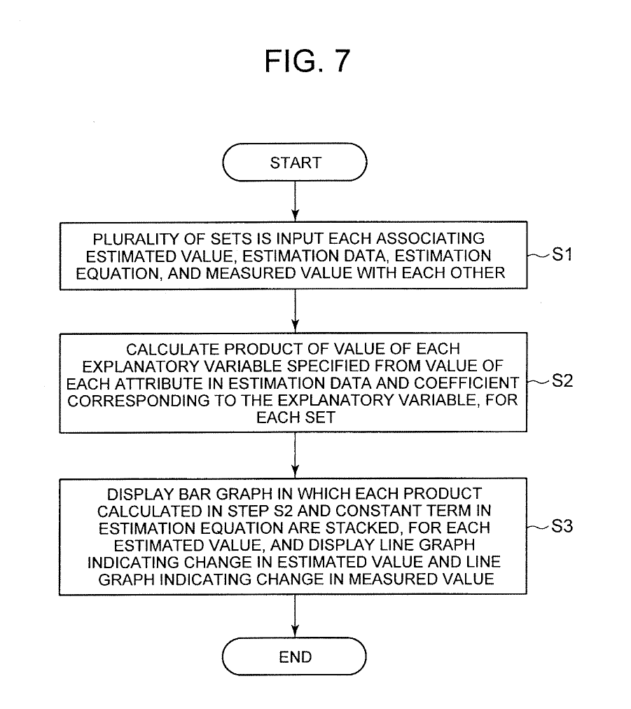

FIG. 7 is a flowchart illustrating an example of processing progress of the first exemplary embodiment. First, the plurality of sets is input to the input means 2, each associating the estimated value, the estimation data used in calculation of the estimated value, the estimation equation used in calculation of the estimated value, and the measured value with each other (step S1). The calculation means 3 takes in the estimated value, the estimation data, and the estimation equation for each set from the information input to the input means 2. In addition, the display means 4 takes in the measured value for each set from the information input to the input means 2.

Next, the calculation means 3 calculates the product of the value of each explanatory variable specified from the value of each attribute in the estimation data and the coefficient corresponding to the explanatory variable, for each set (step S2). Since operation of the calculation means 3 was described above, a detailed description thereof will be omitted here.

Next, the display means 4 displays the bar graph in which each product calculated in step S2 and the constant term in the estimation equation are stacked, for each estimated value, and displays the line graph indicating the change in the estimated value and the line graph indicating the change in the measured value (step S3). Since operation of the display means 4 was also described above, a detailed description thereof will be omitted here.

As a result of step S3, the graph exemplified in FIG. 6 is displayed.

The display means 4 displays the stacked bar graph in which each term in the estimation equation used in calculation of the estimated value is stacked, for each estimated value, and displays the graph indicating the change in the estimated value and the graph indicating the change in the measured value. Therefore, the operator of the display system for displaying analytical information 1 can confirm whether the estimated value and the measured value are about the same as each other, or whether the measured value largely deviates from the estimated value, and further can confirm the magnitude of the value of each term in the estimation equation used in calculation of the estimated value. As a result, when the measured value largely deviates from the estimated value, the operator can easily analyze which term in the estimation equation causes the estimation failure.

Specifically, when the measured value largely deviates from the estimated value, and the measured value is greater than the estimated value, it can be analyzed that the measured value deviates from the estimated value due to a term that is a positive value and whose value is remarkably larger, of the terms in the estimation equation used in calculation of the estimated value. For example, in the display for “August 3” illustrated in FIG. 6, the measured value largely deviates from the estimated value, and the measured value is greater than the estimated value. In addition, the value of the x₅ term is positive, and is a remarkably larger value than the values of the other terms. From this, the operator can easily analyze that the measured value deviates from the estimated value due to the explanatory variable x₅ term (a₅x₅).

In addition, when the measured value largely deviates from the estimated value, and the measured value is less than estimated value, it can be analyzed that the measured value deviates from the estimated value due to a term that is a negative value and whose value is remarkably larger, of the terms in the estimation equation used in calculation of the estimated value. For example, in the display for “August 6” illustrated in FIG. 6, the measured value largely deviates from the estimated value, and the measured value is less than the estimated value. In addition, the value of the x₃ term is negative and is a remarkably larger value than the values of the other terms. From this, the operator can easily analyze that the measured value deviates from the estimated value due to the explanatory variable x₃ term (a₃x₃).

The operator of the display system for displaying analytical information 1 may operate the learning device 11, and may also be an analyst analyzing accuracy of the estimation equation. In this case, as described above, the analyst can specify the term causing the large deviation of the measured value from the estimated value to improve quality of work for analyzing accuracy of the estimation equation and reduce the number of man hours for analysis work. For example, it is assumed that the term causing the large deviation of the measured value from the estimated value is the term of the explanatory variable corresponding to the value “sunny with occasional rain” of the categorical variable “forecast weather.” In that case, “sunny with occasional rain” is a phenomenon that rarely occurs, so that it can be easily considered that the coefficient of the explanatory variable is not appropriate, and it can be used as a material for considering improvement of accuracy of the estimation equation.

In addition, the operator of the display system for displaying analytical information 1 may also be an operator of the estimation device 12. For example, it is assumed that a storekeeper of a convenience store obtains an estimated value of the number of sales of rice balls with the estimation device 12 to estimate the number of rice balls to be ordered. Such a storekeeper specifies a term causing a large deviation of a measured value from the estimated value with the display system for displaying analytical information 1, and can understand the large deviation of the measured value from the estimated value. When the storekeeper described above cannot obtain such an understanding sense, it may happen that the storekeeper does not use the estimation device 12 any longer. However, with the present invention, the storekeeper can obtain the understanding sense to the large deviation of the measured value from the estimated value, and it can be expected that the estimation device 12 is continuously used. Incidentally, here, the storekeeper of the convenience store is exemplified as the operator of the display system for displaying analytical information 1; however, the operator of the display system for displaying analytical information 1 is not limited to such a storekeeper. The same applies to the following description.

In addition, in some cases, although the measured value largely deviates from the estimated value, the term whose value is remarkably larger does not exist. In that case, the operator of the display system for displaying analytical information 1 can consider that the measured value deviates from the estimated value due to a phenomenon not represented as an explanatory variable in the estimation equation. For example, it is assumed that the operator of the display system for displaying analytical information 1 is, for example, a storekeeper of a convenience store, and operates the estimation device 12. It is assumed that the number of rice balls actually sold on one day is extremely greater than the estimated value. In addition, it is assumed that the term whose value is remarkably larger does not exist in the stacked bar graph for the day. Further, it is assumed that, for example, an event is held in the neighborhood on the day but a term corresponding to presence of such an event is not included in the estimation equation. In that case, the storekeeper can consider that a phenomenon not represented as an explanatory variable in the estimation equation (in this example, the event) occurs, and many event participants visit the store, so that the measured value is greater than the estimated value.

Further, it is assumed that the storekeeper described above provides the estimation data and the estimated value obtained by the estimation device 12 to an analyst, and the analyst uses those data for relearning of the estimation equation. In addition, it is assumed that the event described above occurs extremely rarely. In this case, the storekeeper described above excludes the data of the event date from the data to be provided to the analyst, whereby excessive learning based on the phenomenon that occurs extremely rarely can be prevented. As a result, accuracy of the estimation equation obtained by the analyst through relearning can be improved.

In the first exemplary embodiment, the estimation equation may be one estimation equation obtained by multiple regression analysis.

### Second Exemplary Embodiment

In a second exemplary embodiment, it is assumed that, for example, a learning device 11 generates a plurality of estimation equations, and an estimation device 12 selects an estimation equation depending on estimation data to calculate an estimated value. That is, there is a plurality of types of estimation equations to be used for calculating the estimated value. Each of the estimation equations is expressed in a form of Equation (1).

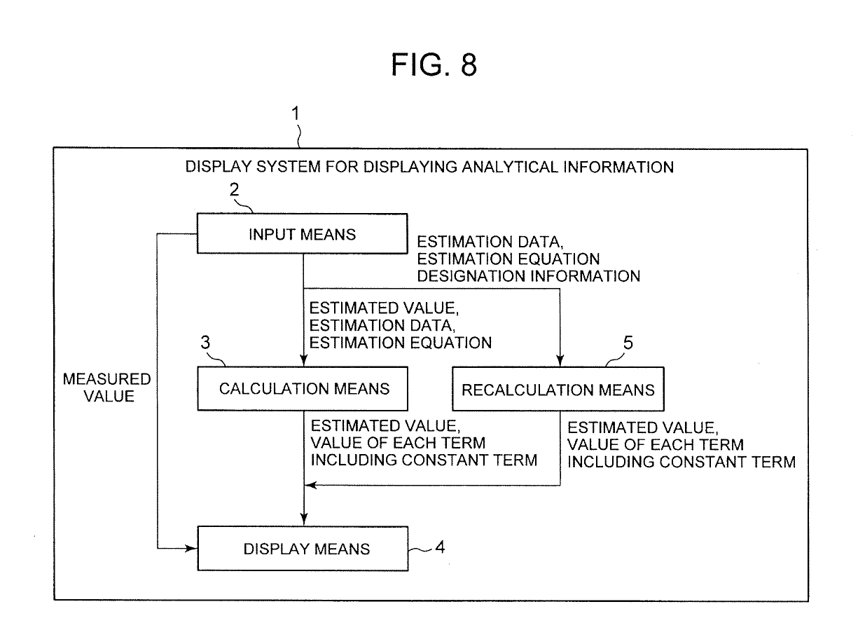

FIG. 8 is a block diagram illustrating an example of a display system for displaying analytical information of the second exemplary embodiment of the present invention. The same components as those of the first exemplary embodiment are denoted by the same reference numerals as those in FIG. 5, and a detailed description thereof will be omitted. A display system for displaying analytical information 1 includes an input means 2, a calculation means 3, a display means 4, and a recalculation means 5.

The calculation means 3 is the same as the calculation means 3 in the first exemplary embodiment, and the description thereof will be omitted.

The display means 4 displays a graph, based on information input from the calculation means 3. This point is the same as that of the first exemplary embodiment. However, in the second exemplary embodiment, the display means 4 re-displays the graph newly (in other words, updates the graph) when the information is input from the recalculation means 5.

As with the first exemplary embodiment, a plurality of sets is input to the input means 2, each associating the estimated value, the estimation data used in calculation of the estimated value, the estimation equation used in calculation of the estimated value, and a measured value with each other. The recalculation means 5 takes in the estimation data for each set from the information input to the input means 2.

In addition, the display means 4 displays the graph similarly to the first exemplary embodiment, and then the information of the estimation equation designated by an operator of the display system for displaying analytical information 1 (hereinafter, referred to as estimation equation designation information) is input to the input means 2.

A method for inputting the estimation equation designation information may be, for example, a method using a graphical user interface (GUI) button for sequentially switching between original graph display exemplified in FIG. 6 and graph display of when each estimation equation is designated, for each click operation, a pull-down menu for selecting the estimation equation, and the like.

The recalculation means 5 stores the plurality of types of estimation equations to be used for calculating the estimated value, in advance. When the estimation equation designation information is input to the input means 2, the recalculation means 5 takes in the estimation equation designation information, and specifies the estimation equation indicated by the estimation equation designation information. Hereinafter, this estimation equation is referred to as a designated estimation equation.

The recalculation means 5 calculates the estimated value, based on a value of each attribute in the estimation data and the designated estimation equation, for each piece of the estimation data. When the attribute is a continuous variable, the recalculation means 5 substitutes the value of the attribute into an explanatory variable in the designated estimation equation corresponding to the attribute. In addition, when the attribute is a categorical variable, the recalculation means 5 substitutes 1 of two values (0 or 1) into the explanatory variable corresponding to the value of the attribute, and substitutes 0 of the two values into explanatory variables respectively corresponding to other possible values of the attribute. The recalculation means 5 performs substitution as described above, and calculates the estimated value of when the designated estimation equation is used.

In addition, the recalculation means 5, for each estimated value calculated by using the designated estimation equation, refers to the value of each attribute in the estimation data, and refers to a coefficient of the explanatory variable in the designated estimation equation. Then, the recalculation means 5 calculates a product of a value of the explanatory variable specified from each of the values of the attributes and the coefficient corresponding to the explanatory variable. This calculation of the product is the same as the calculation of the product executed by the calculation means 3 except for using only the designated estimation equation.

That is, when the attribute is a continuous variable, the recalculation means 5 calculates a product of the value of the attribute and the coefficient of the explanatory variable corresponding to the attribute.

In addition, when the attribute is a categorical variable, the recalculation means 5 specifies explanatory variables respectively corresponding to the possible values of the categorical variable. Then, the recalculation means 5 sets the value of the explanatory variable corresponding to the value of the attribute to 1, and sets the values of the explanatory variables respectively corresponding to other possible values of the attribute to 0. Then, the recalculation means 5 calculates a product of the value of the explanatory variable and the corresponding coefficient, for each explanatory variable.

By calculation as described above, the recalculation means 5 calculates each value of terms from a₁x₁ to aₙxₙ in the designated estimation equation. The recalculation means 5 performs the calculation for each estimated value calculated by using the designated estimation equation. In addition, the recalculation means 5 may execute the calculation of the product described above together with the calculation of the estimated value.

The recalculation means 5 inputs each set of the values of the terms in the designated estimation equation calculated for each estimated value and a value of a constant term b, the estimated value, and time corresponding to the estimated value, to the display means 4.

When the information described above is input from the recalculation means 5, the display means 4 re-displays the graph newly, based on the information. Operation of displaying the graph based on the information input from the recalculation means 5 by the display means 4 is the same as operation of displaying the graph based on the information input from the calculation means 3 by the display means 4. That is, the display means 4 displays the new graph as follows.

The display means 4 displays a stacked bar graph in which each product (that is, each term from a₁x₁ to aₙxₙ) calculated by the recalculation means 5 and the constant term b are stacked, for each estimated value, in chronological order. As described in the first exemplary embodiment, when the calculated product is 0, the product does not appear on the stacked bar graph.

The display means 4, in display of the stacked bar graph, when the product calculated by the recalculation means 5 is positive, stacks and displays the product in the positive direction, and when the product calculated by the recalculation means 5 is negative, stacks and displays the product in the negative direction. Similarly, the display means 4, when the constant term in the designated estimation equation is positive, stacks and displays the constant term in the positive direction, and when the constant term is negative, stacks and displays the constant term in the negative direction.

Further, the display means 4 displays the stacked bar graph, and uses the estimated value input from the recalculation means 5 (estimated value calculated by the designated estimation equation) to display a change in the estimated value with the time change. Further, the display means 4 uses the measured value taken for each set from the information input to the input means 2 to display the change in the measured value with the time change. The display means 4 respectively displays the change in the estimated value and the change in the measured value with the time change with line graphs, for example.

At this time, the display means 4 uses common vertical and horizontal axes to superimpose and display the bar graph and two types of line graphs.

The calculation means 3, the display means 4, and the recalculation means 5 are realized by a CPU of a computer including a display device, for example. In this case, the CPU only needs to read a program for displaying analytical information from a program recording medium such as a program storage device (not illustrated in FIG. 8) of the computer, and operate as the calculation means 3, the display means 4, and the recalculation means 5 in accordance with the program for displaying analytical information. In addition, the calculation means 3, the display means 4, and the recalculation means 5 may be realized by separate hardware devices, respectively.

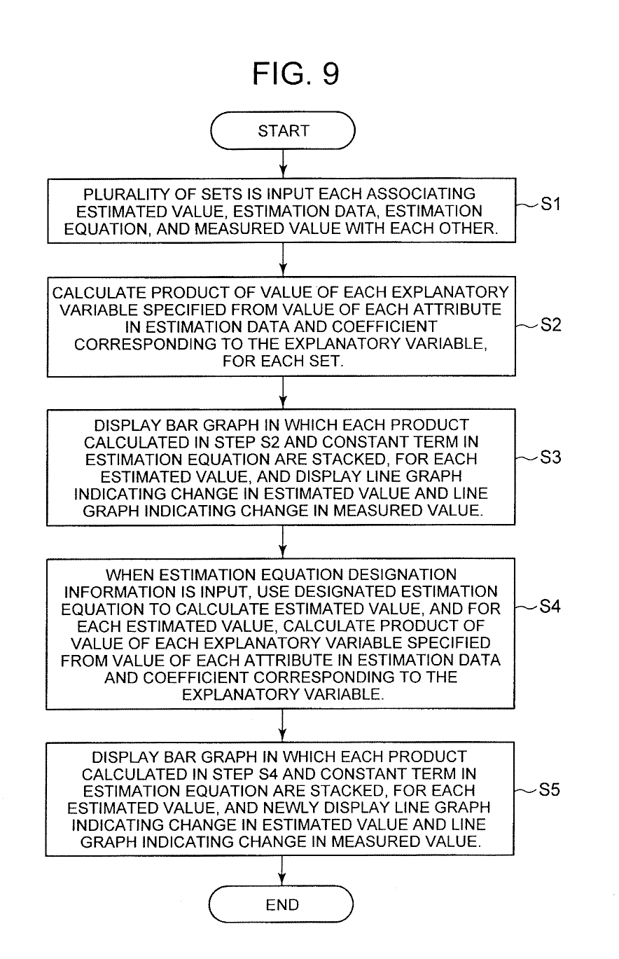

FIG. 9 is a flowchart illustrating an example of processing progress of the second exemplary embodiment. First, the plurality of sets is input to the input means 2, each associating the estimated value, the estimation data, the estimation equation, and the measured value with each other (step S1). Step S1 is the same as step S1 in the first exemplary embodiment. The calculation means 3 takes in the estimated value, the estimation data, and the estimation equation for each set from the information input to the input means 2. In addition, the display means 4 takes in the measured value for each set from the information input to the input means 2. The recalculation means 5 takes in the estimation data for each set from the information input to the input means 2.

Steps S2, S3 are the same as steps S2, S3 in the first exemplary embodiment, and the description thereof will be omitted. Incidentally, as described in the first exemplary embodiment, as a result of step S3, the graph exemplified in FIG. 6 is displayed.

After step S3, when the estimation equation designation information is input to the input means 2, the recalculation means 5 takes in the estimation equation designation information, and specifies the estimation equation (designated estimation equation) indicated by the estimation equation designation information. Then, the recalculation means 5 uses the designated estimation equation to calculate the estimated value for each piece of the estimation data, and for each estimated value calculated, calculates the product of the value of each explanatory variable specified from the value of each attribute in the estimation data and the coefficient in the designated estimation equation corresponding to the explanatory variable (step S4). Since operation of the recalculation means 5 was described above, a detailed description will be omitted here.

Next, the display means 4, for each estimated value calculated in step S4, displays the stacked bar graph in which each product calculated in step S4 and the constant term in the designated estimation equation are stacked, and displays the line graph indicating the change in the estimated value calculated in step S4 (the change in the estimated value with the time change), and the line graph indicating the change in the measured value (step S5). Since operation of the display means 4 in step S5 was also described above, a detailed description will be omitted here.

Hereinafter, a specific example of the graph displayed newly in step S5 will be described. In the following description, it is assumed that the display means 4 displays the graph illustrated in FIG. 6 in step S3. In the graph exemplified in FIG. 6, the estimation equation used for estimated value calculation for each date is not always one type. In the example illustrated in FIG. 6, it is assumed that the estimated values for “August 1,” “August 2,” and “August 4” are calculated by using the estimation equation 1. It is assumed that the estimated value for “August 3” is calculated by using the estimation equation 2. It is assumed that the estimated value for “August 5” is calculated by using the estimation equation 3. It is assumed that the estimated value for “August 6” is calculated by using the estimation equation 4.

It is assumed that, after the graph exemplified in FIG. 6 is displayed, for example, the operator of the display system for displaying analytical information 1 inputs the estimation equation designation information designating the “estimation equation 1.” In this case, the designated estimation equation is the estimation equation 1. Hereupon, the recalculation means 5 uses the estimation equation 1 to calculate the estimated value for each piece of the estimation data, and for each estimated value calculated, calculates the product of the value of each explanatory variable specified from the value of each attribute in the estimation data and the coefficient in the designated estimation equation corresponding to the explanatory variable (step S4).

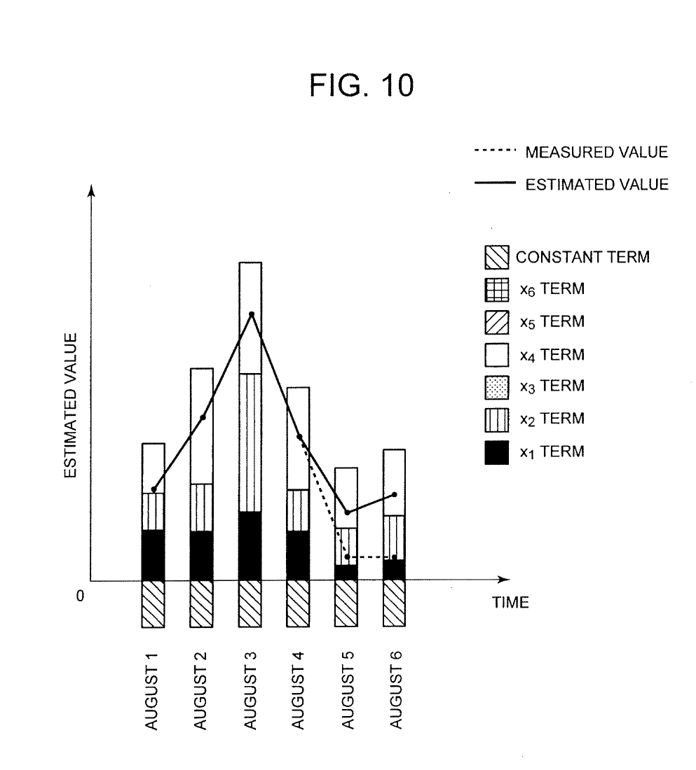

The display means 4 uses a result calculated in step S4 to display the graph newly in step S5. FIG. 10 illustrates an example of a graph displayed in step S5, as a result of designation of the estimation equation 1. The solid line graph indicates the change in the estimated value for each date calculated by the estimation equation 1 in step S4. The dashed line graph indicates the change in the measured value for each date. For the portion where the solid line graph and the dashed line graph overlap each other, only the solid line is indicated. The line graph indicating the change in the measured value is the same as the line graph indicating the change in the measured value in FIG. 6.

In the example illustrated in FIG. 6, the estimated values for “August 1,” “August 2,” and “August 4” are calculated by using the estimation equation 1. Therefore, the estimated values and the stacked bar graphs for “August 1,” “August 2,” and “August 4” illustrated in FIG. 10 are the same as the estimated values and the stacked bar graphs for “August 1,” “August 2,” and “August 4” illustrated in FIG. 6.

In addition, in the example illustrated in FIG. 6, the estimated values for “August 3,” “August 5,” and “August 6” are calculated by using an estimation equation other than the estimation equation 1. Therefore, the estimated values and the stacked bar graphs for “August 3,” “August 5,” and “August 6” illustrated in FIG. 10 are changed from the estimated values and the stacked bar graphs for “August 3,” “August 5,” and “August 6” illustrated in FIG. 6.

When it is focused on the estimated value, the measured value, and the stacked bar graph for “August 3” illustrated in FIG. 10, the estimated value does not deviate from the measured value. In addition, it can be determined that the value of each term in the estimation equation 1 indicated by the stacked bar graph is an appropriate value. Therefore, the operator can determine that use of the estimation equation 1 is appropriate for estimation for “August 3,” and can consider relearning a selection model so that the estimation equation 1 is selected for the estimation data for “August 3.”

In addition, the operator can confirm that the estimated value for “August 5” does not deviate from the measured value when the estimation equation 3 is used (see FIG. 6), but deviates from the measured value due to use of the estimation equation 1. That is, the operator can confirm that the estimation equation 3 selected for calculating the estimated value for “August 5” is appropriate.

In addition, the operator can confirm that the estimated value for “August 5” deviates from the measured value when the estimated value 4 is used (see FIG. 6), and deviates from the measured value also when the estimation equation 1 is used. In this case, to confirm which estimation equation is appropriate for estimated value calculation for “August 5,” the operator further input the estimation equation designation information, and the display system for displaying analytical information only needs to execute steps S4, S5, again.

With the present exemplary embodiment, the same effect as that of the first exemplary embodiment can be obtained. Further, since confirmation as described above can be performed, when the estimated value deviates from the measured value, an analyst can consider searching an appropriate estimation equation and relearning the selection model.

When the graph exemplified in FIG. 6 is displayed, the analyst confirms that the estimated value for “August 3” deviates from the measured value, and inputs estimation equation designation information designating another estimation equation to confirm the estimated value of when the other estimation equation is used. Here, for example, as an equation in which a term not appearing in the bar graph for “August 3” in FIG. 6 (for example, x₁ term) appears, the estimation equation 1 may be designated. As a result, in the graph displayed newly (see FIG. 10), the estimated value for “August 3” does not deviate from the measured value. For that reason, it is possible to consider relearning the selection model so that the estimation equation 1 is selected for the estimation data for “August 3.”

In addition, for example, regardless of the estimation equation designated, the estimated value may deviate from the measured value, or an inappropriate value may be included in the term represented in the stacked bar graph. In that case, the analyst determines that an appropriate estimated value cannot be obtained from the estimation data with only an existing attribute and it is necessary to consider a new attribute in calculating the estimated value, and can consider such a new attribute, or consider learning the estimation equation including an explanatory variable corresponding to the new attribute.

### Third Exemplary Embodiment

In each exemplary embodiment described above, a description has been made using an example in which the plurality of sets is input, the sets each associating the estimated value calculated already, the estimation data used in calculation of the estimated value, the estimation equation used in calculation of the estimated value, and the measured value with each other. In a third exemplary embodiment, a display system for displaying analytical information selects an estimation equation, and uses the estimation equation to calculate an estimated value.

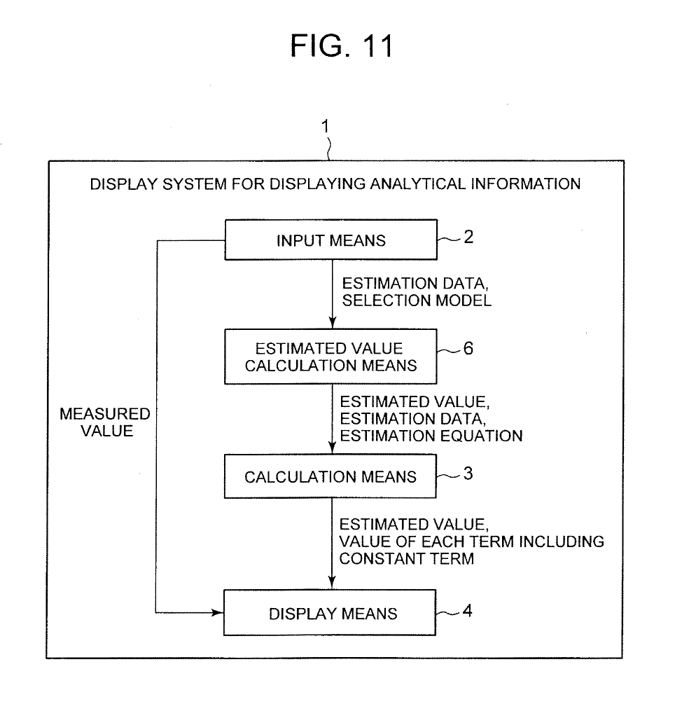

FIG. 11 is a block diagram illustrating an example of a display system for displaying analytical information of the third exemplary embodiment of the present invention. The same components as those of the first exemplary embodiment are denoted by the same reference numerals as those in FIG. 5, and a detailed description thereof will be omitted. A display system for displaying analytical information 1 includes an input means 2, a calculation means 3, a display means 4, and an estimated value calculation means 6.

In the present exemplary embodiment, the input means 2 is an input device to which a plurality of sets is input, the sets each associating estimation data used for estimated value calculation and a measured value with each other, and to which a selection model is input.

As described above, each piece of the estimation data includes values of two or more types of attributes.

In addition, the selection model is a model for selecting the estimation equation, and is expressed by a tree structure model as exemplified in FIG. 2, for example. However, a form of the selection model is not limited to the tree structure model. Incidentally, estimation equations to be selection candidates are all expressed in a form of Equation (1).

The estimated value calculation means 6 takes in the estimation data from information input to the input means 2 for each set, and also takes in the selection model.

The estimated value calculation means 6 selects the estimation equation, based on the selection model, for each piece of the estimation data. For example, it is assumed that the selection model is a tree structure model as exemplified in FIG. 2. In this case, the estimated value calculation means 6, starting from a root node of the selection model, traces nodes while repeating selection of any one of two child nodes depending on whether or not the estimation data satisfies the condition indicated by the nodes. When reaching a leaf node, the estimated value calculation means 6 selects the estimation equation indicated by the leaf node.

Further, the estimated value calculation means 6 uses the selected estimation equation, and the estimation data used for selection of the estimation equation, to calculate the estimated value. At this time, regarding the attribute being a continuous variable of the attributes in the estimation data, the estimated value calculation means 6 substitutes the value of the attribute into an explanatory variable in a designated estimation equation corresponding to the attribute. In addition, regarding the attribute being a categorical variable, 1 of two values (0 or 1) is substituted into an explanatory variable corresponding to the value of the attribute, and 0 of the two values is substituted into explanatory variables respectively corresponding to other possible values of the attribute. The estimated value calculation means 6 performs substitution into the explanatory variable in this way, to calculate the estimated value.

The estimated value calculation means 6 inputs each set associating the estimation data, the estimation equation selected based on the estimation data, and the estimated value calculated based on the estimation data and the estimation equation with each other, to the calculation means 3.

The calculation means 3 and the display means 4 are respectively the same as calculation means 3 and the display means 4 in the first exemplary embodiment.

The estimated value calculation means 6, the calculation means 3, and the display means 4 are realized by a CPU of a computer including a display device, for example. In this case, the CPU only needs to read a program for displaying analytical information from a program recording medium such as a program storage device (not illustrated in FIG. 11) of the computer, and operate as the estimated value calculation means 6, the calculation means 3, and the display means 4 in accordance with the program for displaying analytical information. In addition, the estimated value calculation means 6, the calculation means 3, and the display means 4 may be realized by separate hardware devices, respectively.

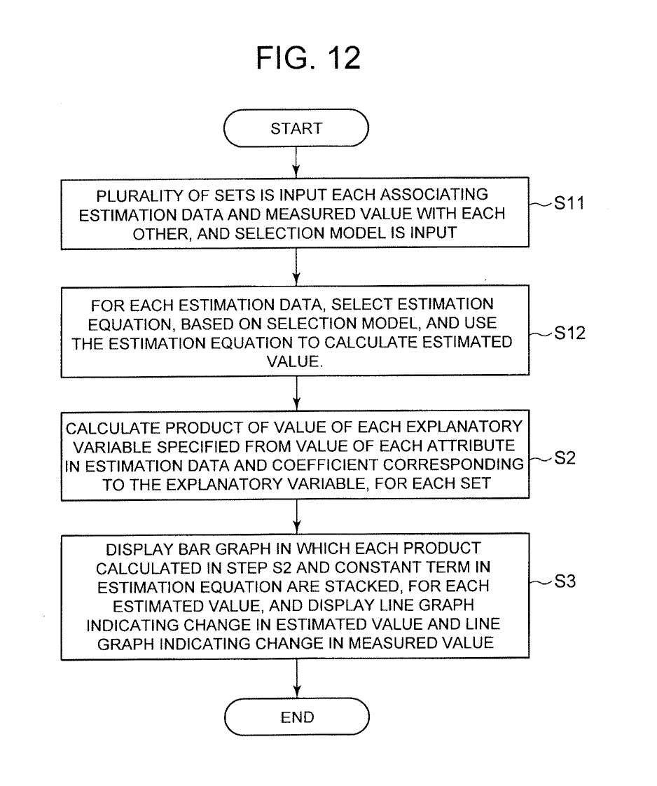

FIG. 12 is a flowchart illustrating an example of processing progress of the third exemplary embodiment. To the input means 2, a plurality of sets each associating the estimation data and the measured value with each other is input, and the selection model is input (step S11). The estimated value calculation means 6 takes in the estimation data from information input to the input means 2 for each set, and also takes in the selection model. In addition, the display means 4 takes in the measured value for each set from the information input to the input means 2.

The estimated value calculation means 6, for each piece of the estimated data, selects the estimation equation, based on the selection model, and uses the estimated data and the estimation equation, to calculate the estimated value (step S12). Since operation of the estimated value calculation means 6 was described above, a detailed description will be omitted here.

The estimated value calculation means 6 inputs each set associating the estimation data, the estimation equation selected based on the estimation data, and the estimated value calculated based on the estimation data and the estimation equation with each other, to the calculation means 3. As a result, the calculation means 3 obtains the same information as the information taken from the input means 2 in the first exemplary embodiment.

Operation of steps S2, S3 subsequent to step S12 is the same as operation of steps S2, S3 in the first exemplary embodiment, and the description thereof will be omitted.

Also in the present exemplary embodiment, the same effect as that of the first exemplary embodiment can be obtained. In addition, when the first exemplary embodiment and the third exemplary embodiment are compared with each other, in the third exemplary embodiment, the estimated value calculation means 6 selects the estimation equation and calculates the estimated value, so that an effect can be obtained that an operator does not have to input the estimated value and the estimation equation. In addition, in the first exemplary embodiment, the estimated value calculation means 6 does not have to be provided, so that an effect can be obtained that the configuration of the display system for displaying analytical information 1 can be simplified.

In addition, the second exemplary embodiment may be applied to the third exemplary embodiment. That is, the display system for displaying analytical information 1 of the third exemplary embodiment may further include the recalculation means 5 in the second exemplary embodiment. In this case, after step S3 illustrated in FIG. 12, the recalculation means 5 only needs to execute step S4 in the second exemplary embodiment, and the display means 4 only needs to execute step S5 in the second exemplary embodiment. In this case, the same effect can also be obtained as that of the second exemplary embodiment.

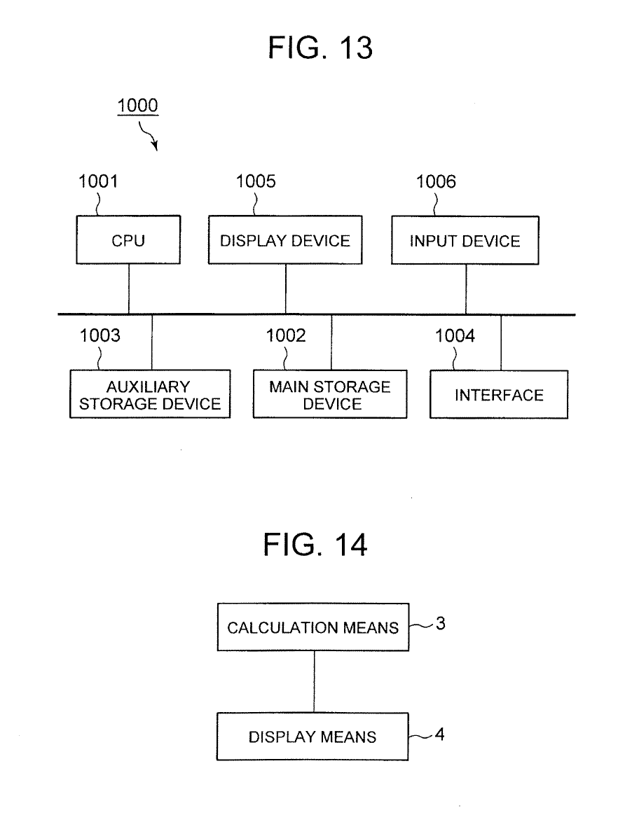

FIG. 13 is a schematic block diagram illustrating a configuration example of a computer according to each exemplary embodiment of the present invention. A computer 1000 includes a CPU1001, a main storage device 1002, an auxiliary storage device 1003, an interface 1004, a display device 1005, and an input device 1006.

The display system for displaying analytical information 1 of each exemplary embodiment is implemented in the computer 1000. Operation of the display system for displaying analytical information 1 is stored in a form of a program (program for displaying analytical information) in the auxiliary storage device 1003. The CPU1001 reads the program from the auxiliary storage device 1003 to deploy the program on the main storage device 1002, and executes the process described above in accordance with the program.

The auxiliary storage device 1003 is an example of a non-transitory tangible medium. Examples of the non-transitory tangible medium include a magnetic disk, a magneto-optical disk, CD-ROM, DVD-ROM, and a semiconductor memory connected via the interface 1004. In addition, when the program is delivered to the computer 1000 via a communication line, the computer 1000 to which the program is delivered may deploy the program on the main storage device 1002 to execute the process described above.

In addition, the program may be a program for partially realizing the process described above. Further, the program may be a differential program that realizes the process described above in combination with another program stored already in the auxiliary storage device 1003.

Next, an outline of the present invention will be described. FIG. 14 is a block diagram illustrating an outline of a display system for displaying analytical information of the present invention. The display system for displaying analytical information of the present invention includes a calculation means 3 and a display means 4.

The calculation means 3 uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value.

The display means 4 displays a stacked bar graph in which each product calculated by the calculation means 3 and a constant term in the estimation equation are stacked, for each estimated value, and respectively displays a change in the estimated value and a change in a measured value corresponding to the estimated value.

Such a configuration allows a person to easily analyze which term in the estimation equation causes the estimation failure, when the measured value largely deviates from the estimated value.

Each exemplary embodiment described above can be described as the following supplementary notes; however, it is not limited thereto.

### (Supplementary Note 1)

A display system for displaying analytical information, including: a calculation means that uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and a display means that displays a stacked bar graph in which each product calculated by the calculation means and a constant term in the estimation equation are stacked, for each estimated value, and respectively displays a change in the estimated value and a change in a measured value corresponding to the estimated value.

### (Supplementary Note 2)

The display system for displaying analytical information according to supplementary note 1, wherein the display means, in display of a stacked bar graph, when a product calculated is positive, stacks the product in a positive direction, and when the product is negative, stacks the product in a negative direction, and when a constant term in an estimation equation is positive, stacks the constant term in the positive direction, and when the constant term is negative, stacks the constant term in the negative direction.

### (Supplementary Note 3)

The display system for displaying analytical information according to supplementary note 1 or supplementary note 2, further including a recalculation means that, when an estimation equation is designated, calculates an estimated value, based on values of two or more types of attributes and the estimation equation designated, and for each estimated value calculated, uses the values of two or more types of attributes and a coefficient in the estimation equation, to calculate a product of a value of an explanatory variable specified from each of the values of the attributes and the coefficient corresponding to the explanatory variable, wherein the display means, for each estimated value obtained by the recalculation means, displays a stacked bar graph in which each product calculated by the recalculation means and a constant term in the estimation equation are stacked, and respectively displays a change in the estimated value and a change in a measured value corresponding to the estimated value.

### (Supplementary Note 4)

The display system for displaying analytical information according to any of supplementary note 1 to supplementary note 3, wherein the display means respectively displays a change in an estimated value and a change in a measured value with line graphs.

### (Supplementary Note 5)

The display system for displaying analytical information according to any of supplementary note 1 to supplementary note 4, further including an input means to which a plurality of sets is input, the sets each associating an estimated value, values of two or more types of attributes used in calculation of the estimated value, an estimation equation used in calculation of the estimated value, and a measured value with each other.

### (Supplementary Note 6)

The display system for displaying analytical information according to any of supplementary note 1 to supplementary note 4, further including: an input means to which a plurality of sets is input, the sets each associating values of two or more types of attributes used for estimated value calculation and a measured value with each other, and to which a selection model for selecting an estimation equation used for estimated value calculation is input; and an estimated value calculation means that, for each of the sets, selects an estimation equation, based on the values of two or more types of attributes and the selection model, and calculates an estimated value, based on the values of two or more types of attributes and the estimation equation.

### (Supplementary Note 7)

A method for displaying analytical information including: using values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and displaying a stacked bar graph in which each product calculated and a constant term in the estimation equation are stacked, for each estimated value, and respectively displaying a change in the estimated value and a change in a measured value corresponding to the estimated value.

### (Supplementary Note 8)

The method for displaying analytical information according to supplementary note 7, wherein, in display of a stacked bar graph, when a product calculated is positive, the product is stacked in a positive direction, and when the product is negative, the product is stacked in a negative direction, and when a constant term in an estimation equation is positive, the constant term is stacked in the positive direction, and when the constant term is negative, the constant term is stacked in the negative direction.

### (Supplementary Note 9)

A program for displaying analytical information causing a computer to execute: a calculation process that uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and a display process that displays a stacked bar graph in which each product calculated in the calculation process and a constant term in the estimation equation are stacked, for each estimated value, and respectively displays a change in the estimated value and a change in a measured value corresponding to the estimated value.

### (Supplementary Note 10)

The program for displaying analytical information according to supplementary note 9, causing a computer, in the display process, in display of a stacked bar graph, when a product calculated is positive, to stack the product in a positive direction, and when the product is negative, to stack the product in a negative direction, and when a constant term in an estimation equation is positive, to stack the constant term in the positive direction, and when the constant term is negative, to stack the constant term in the negative direction.

In the above, the present invention has been described with reference to the exemplary embodiments; however, the present invention is not limited to the exemplary embodiments described above. Various modifications that can be understood by those skilled in the art within the scope of the present invention can be made to the configuration and details of the present invention.

This application claims priority based on Japanese Patent Application No. 2015-023082 filed on Feb. 9, 2015, the disclosure of which is incorporated herein in its entirety.

### INDUSTRIAL APPLICABILITY

The present invention is suitably applied to analysis of an estimation equation.

### REFERENCE SIGNS LIST

1 Display system for displaying analytical information
2 Input means
3 Calculation means
4 Display means
5 Recalculation means
6 Estimated value calculation means

1. A display system for displaying analytical information, comprising:
a calculation unit that uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and
a display unit that displays a stacked bar graph in which each product calculated by the calculation unit and a constant term in the estimation equation are stacked, for each estimated value, and respectively displays a change in the estimated value and a change in a measured value corresponding to the estimated value.

2. The display system for displaying analytical information according to claim 1, wherein
the display unit, in display of a stacked bar graph, when a product calculated is positive, stacks the product in a positive direction, and when the product is negative, stacks the product in a negative direction, and when a constant term in an estimation equation is positive, stacks the constant term in the positive direction, and when the constant term is negative, stacks the constant term in the negative direction.

3. The display system for displaying analytical information according to claim 1, further comprising
a recalculation unit that, when an estimation equation is designated, calculates an estimated value, based on values of two or more types of attributes and the estimation equation designated, and for each estimated value calculated, uses the values of two or more types of attributes and a coefficient in the estimation equation, to calculate a product of a value of an explanatory variable specified from each of the values of the attributes and the coefficient corresponding to the explanatory variable, wherein
the display unit, for each estimated value obtained by the recalculation unit, displays a stacked bar graph in which each product calculated by the recalculation unit and a constant term in the estimation equation are stacked, and respectively displays a change in the estimated value and a change in a measured value corresponding to the estimated value.

4. The display system for displaying analytical information according to claim 1, wherein
the display unit respectively displays a change in an estimated value and a change in a measured value with line graphs.

5. The display system for displaying analytical information according to claim 1, further comprising
an input unit to which a plurality of sets is input, the sets each associating an estimated value, values of two or more types of attributes used in calculation of the estimated value, an estimation equation used in calculation of the estimated value, and a measured value with each other.

6. The display system for displaying analytical information according to claim 1, further comprising:
an input unit to which a plurality of sets is input, the sets each associating values of two or more types of attributes used for estimated value calculation and a measured value with each other, and to which a selection model for selecting an estimation equation used for estimated value calculation is input; and
an estimated value calculation unit that, for each of the sets, selects an estimation equation, based on the values of two or more types of attributes and the selection model, and calculates an estimated value, based on the values of two or more types of attributes and the estimation equation.

7. A method for displaying analytical information comprising:
using values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and
displaying a stacked bar graph in which each product calculated and a constant term in the estimation equation are stacked, for each estimated value, and respectively displaying a change in the estimated value and a change in a measured value corresponding to the estimated value.

8. The method for displaying analytical information according to claim 7, wherein,
in display of a stacked bar graph, when a product calculated is positive, the product is stacked in a positive direction, and when the product is negative, the product is stacked in a negative direction, and when a constant term in an estimation equation is positive, the constant term is stacked in the positive direction, and when the constant term is negative, the constant term is stacked in the negative direction.

9. A non-transitory computer-readable recording medium in which a program for displaying analytical information is recorded,
the program causing a computer to execute:
a calculation process that uses values of two or more types of attributes used in calculation of an estimated value, and a coefficient of an explanatory variable in an estimation equation used in calculation of the estimated value, to calculate a product of a value of the explanatory variable specified from each of the values of the attributes and the coefficient corresponding to the explanatory variable, for each estimated value; and
a display process that displays a stacked bar graph in which each product calculated in the calculation process and a constant term in the estimation equation are stacked, for each estimated value, and respectively displays a change in the estimated value and a change in a measured value corresponding to the estimated value.

10. The non-transitory computer-readable recording medium in which the program for displaying analytical information is recorded, according to claim 9,
the program causing a computer,
in the display process, in display of a stacked bar graph, when a product calculated is positive, to stack the product in a positive direction, and when the product is negative, to stack the product in a negative direction, and when a constant term in an estimation equation is positive, to stack the constant term in the positive direction, and when the constant term is negative, to stack the constant term in the negative direction.
